(19) United States
(12) Patent Application Publication
(10) Pub. No.: US 2007/0176328 A1
(43) Pub. Date: Aug. 2, 2007

(54) Organic material decomposition and treatment method using magnetic wave

(76) Inventor: Young Ho Park, Park Ridge, NJ (US)

Correspondence Address: LADAS & PARRY, 26 WEST 61ST STREET, NEW YORK, NY, 10023, US

(21) Appl. No.: 11/369,030

(22) Filed: Mar. 6, 2006

(30) Foreign Application Priority Data
Jan. 31, 2006 (KR) 10-2006-0009380

(51) Int. Cl. H05B 6/00; C01B 31/02

(52) U.S. Cl. 264/405; 264/29.1

(57) ABSTRACT

An organic material decomposition and treatment method using a magnetic wave is disclosed, in which organic materials can be well decomposed without creating or producing harmful materials. The organic material decomposition and treatment method using a magnetic wave comprises a first step in which an organic material is inputted into the interior of a container body, and the container body is sealed; a second step in which the interior of the container body is dried; and a third step in which a magnetic wave is induced in the interior of the container body, whereby a thermal energy is generated while the organic material is decomposed by the magnetic waves, and the organic material is carbonized by the thermal energy.

### BACKGROUND OF THE INVENTION

1. Field of the Invention

The present invention relates to an organic material decomposition and treatment method, and in particular to an organic material decomposition and treatment method using a magnetic wave in which it is possible to achieve a non-pollution decomposition without any harmful material creation and discharge when a waste material of a petrochemical industry organic material and an organic substance is decomposed and treated.

2. Description of the Background Art

In modern society, the use of a disposable type item or a packing material increases, so that an organic material increases and pollutes environments. As a life standard is enhanced, and industrialization is accelerated, the use of organic materials keeps increasing. The kinds of organic materials are being diversified. The use of organic materials does not decrease despite of the efforts by government such as waste measured rate system, waste separation and disposal system.

Generally, the organic materials have been treated by a burying method, an incineration method or a recycling method. In Korea, the burying method has been adapted, which method has been widely used in the USA. However, in the burying method, it is impossible to recycle the organic materials. In Korea with small area, the burying method cannot be adapted for long time period.

So as to overcome the above problems, the Korean government stopped burying food wastes on January 2005. Namely, according to the regulations, only residuals produced after incineration, compost treatment or extermination could be buried, so that the organic materials can be treated based on incineration and recycling methods.

However, the recycling method may not be economical and may produce secondary pollutants during the treatment.

In the case of the incineration method, various harmful materials such as dioxin, hydrogen chloride, chlorine, hydrogen fluorine, heavy metals, carbon monoxide, nitric compounds, sulfate compounds, etc. are produced a lot for thereby destroying environments and speeding up earth warming phenomenon. So as to comply with the pollutant discharge regulations, an expensive dust collection facility or an expensive high temperature combustion system should be installed. Therefore, the incineration method cannot be practically adapted to the industry.

### SUMMARY OF THE INVENTION

Accordingly, it is an object of the present invention to provide an organic material decomposition and treatment method using a magnetic wave in which organic materials can be well decomposed without creating or producing harmful materials.

To achieve the above object, there is provided an organic material decomposition and treatment method using a magnetic wave which comprises a first step in which an organic material is inputted into the interior of a container body, and the container body is sealed; a second step in which the interior of the container body is dried; and a third step in which a magnetic wave is induced in the interior of the container body, whereby a thermal energy is generated while the organic material is decomposed by the magnetic waves, and the organic material is carbonized by the thermal energy.

An exhaust tube is installed at the container body, so that a gas generated during the decomposition of the organic material is discharged to the outside through the exhaust tube.

The magnetic wave is induced by a magnetic wave generator in the interior of the container body, with the magnetic generator being installed at both sides of the container body, respectively.

### BRIEF DESCRIPTION OF THE DRAWINGS

The present invention will become better understood with reference to the accompanying drawings which are given only by way of illustration and thus are not limitative of the present invention, wherein;

FIG. 1 is a schematic view illustrating an organic material decomposition procedure based on an organic material decomposition and treatment method using a magnetic wave according to the present invention; and

FIG. 2 is a schematic view illustrating a state that an organic material is treated based on an organic material decomposition and treatment method using a magnetic wave according to the present invention.

### DETAILED DESCRIPTION OF THE PREFERRED EMBODIMENTS

Generally, when organic materials are heated at a very high temperature, the components contained therein are thermally decomposed. The heat energy converts chemical components (for example, carbon, hydrogen, etc.) of organic materials into gases. The thermal decomposition process has been generally used so as to thermally decompose and chemically convert the organic materials.

The organic material decomposition and treatment method using a magnetic wave according to the present invention is basically directed to thermally decomposing and carbonizing the organic materials using a magnetic wave, not using a combustion method.

Here, the organic material decomposition and treatment method using a magnetic wave according to the present invention comprises a third step, a second step and a third step.

In the first step, an organic material is inputted into the interior of a container body, and the container body is sealed so as to remove external air, namely, oxygen, so that the organic material does not burn. When the organic material is inputted, a small amount of external air (oxygen) may be inputted into the interior of the container body, and part of the air may be penetrated into the organic material. However, the amount of inputted air is too small so that combustion may be neglected. The inlet of the container body preferably has a certain inclination for an easier input when an organic material is inputted. A lid should be installed at the inlet so that the container body is sealed. When the inlet is installed so that external air is not inputted into the container body, it is possible to continuously input the organic materials by the fixed amount without any input of external air while the organic materials are being decomposed in the interior of the container body.

In the second step, the interior of the container body is dried. Since the organic material inputted into the interior of the container body contains water, it is needed to dry the organic material so that decomposition can be efficiently performed. At this time, it is preferred to heat and dry the interior of the container body. Namely, heating is performed so that the water contained in the organic material is substantially removed.

In the third step, magnetic waves are induced in the interior of the container body. After the first and second steps are performed, the interior of the container body does not have air (oxygen), and the inputted organic material becomes a dried state. In the above state, when magnetic waves are induced in the interior of the container body, the organic material is decomposed by the magnetic waves, and at the same time heat energy is generated. The organic materials are carbonized by the created thermal energy. Here, the magnetic waves are generated by a magnetic wave generator having magnets therein. The magnetic wave generator is preferably installed at both sides of the container body, so that the magnetic waves are more efficiently generated in the interior of the container body. Namely, the magnets provided at the magnetic wave generator are installed at both sides of the container body so that the poles are opposite from N to S. With the above construction, magnetic fields are formed in the interior of the container body. Here, the magnets are neodymium permanent magnets with intensities of 5000 to 70000 Gauss. The above construction and intensities are not limited thereto. The intensities of the magnetic waves can be adjusted based on the kinds of organic materials inputted into the interior of the container body and the size of the container body. Therefore, the numbers of the magnetic wave generator or the magnets installed at the container body are determined based on the kinds of the organic materials, which will be treated, and the size (volume) of the container body. For example, in the case that the volume is 0.5 m³, two magnetic wave generators (totally four generators, and eight magnets) are installed at both side of the container body, respectively. In the case that the volume is 1.0 m³, three magnetic wave generators (totally six generators, and twelve magnets) are installed at both sides of the container body, respectively. In the case that the volume is 1.5 m³, five magnetic wave generators (totally ten generators, and twenty magnets) are installed at both sides of the container body, respectively. As the volume increases, the number of the magnetic wave generator increases. Here, the organic material decomposition apparatus is preferably installed in the direction of the south for thereby more efficiently generating magnetic waves.

When the magnetic waves induced by the magnetic wave generator are induced in the interior of the container body, the organic material is decomposed by the magnetic waves, and at the same time the organic material is decomposed into ashes by generated energy. When the organic material is decomposed into ashes, gas is generated. This gas should be discharged to the outside. An exhaust tube is preferably installed at the container body so as to exhaust the gas. Therefore, the gas generated when the organic material is decomposed is exhausted to the outside. A filter is preferably installed at the exhaust tube so as to filter the gas exhausted into the exhaust tube.

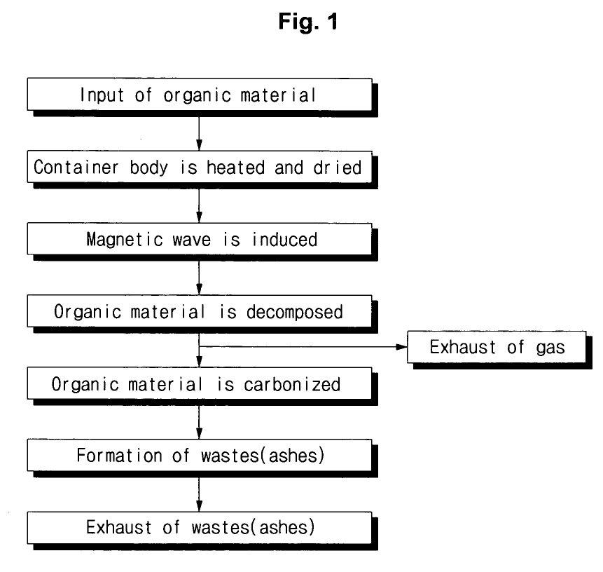

FIG. 1 is a view illustrating a decomposition procedure of an organic material based on an organic material decomposition and treatment method using a magnetic wave according to the present invention. The organic material decomposition procedure will be described with reference to FIG. 1.

First, an organic material is inputted into the container body, and the container body is sealed. The container body is heated, and the interior of the container body and the inputted organic material are dried. The magnetic waves generated by the magnetic wave generator installed at the container body are induced into the interior of the container body. The organic material is decomposed by the magnetic waves, and at the same time a thermal energy is generated. The organic material is carbonized by the generated thermal energy and changes to ashes.

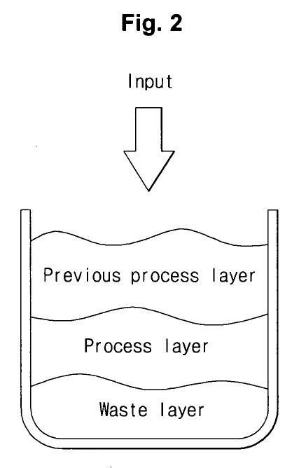

As shown in FIG. 2, when the organic material is decomposed, the decomposition is performed in a layer structure. Namely, the processed organic material changes to ashes and forms waste layers. A decomposition process layer is formed at the upper side of the waste layer in which the decomposition is being performed. While the organic material is being decomposed, it is possible to continuously input organic materials. A previous process layer is formed at the upper side of the decomposition process layer by the inputted organic material. When the process of the decomposition process layer is finished, the organic material changes to ashes for thereby forming a waste layer, and then the decomposition of the organic material, which forms the previous process layer, starts. Thereafter, when the organic material is continuously inputted, the above-described procedures are repeatedly performed. When the decomposition is finished, the waste material is discharged through the outlet of the container body, and the wastes may be used as good quality fertilizer or soil improving materials.

As described above, the organic material decomposition and treatment method using a magnetic wave according to the present invention has the following effect.

First, organic materials are decomposed by magnetic waves, not by a combustion method, in a state that the organic materials are sealed without air. Since a harmful gas such as dioxin or CO₂ does not occur, the organic materials can be treated without producing pollutants.

Second, the organic materials can be continuously decomposed and treated by decomposition heat generated during the decomposition of organic materials, so that a motor or a burner is not additionally needed for thereby decreasing the cost.

Third, after the organic materials are decomposed, since the volume of the residuals decreases to 1/200to 1/300as compared to the original volume, the treatment work is easy. The residuals may be used as good quality fertilizer or soil improving agents.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. An organic material decomposition and treatment method using a magnetic wave, comprising:
a first step in which an organic material is inputted into the interior of a container body, and the container body is sealed;
a second step in which the interior of the container body is dried; and
a third step in which a magnetic wave is induced in the interior of the container body, whereby a thermal energy is generated while the organic material is decomposed by the magnetic waves, and the organic material is carbonized by the thermal energy.

2. The method of claim 1, wherein an exhaust tube is installed at the container body, so that a gas generated during the decomposition of the organic material is discharged to the outside through the exhaust tube.

3. The method of claim 1, wherein said magnetic wave is induced by a magnetic wave generator in the interior of the container body, with the magnetic generator being installed at both sides of the container body, respectively.
